(19) United States
(12) Patent Application Publication
(10) Pub. No.: US 2005/0113724 A1
(43) Pub. Date: May 26, 2005

(54) Vibrator systems, methods of making and operating such systems, apparatus for controlling such systems

(76) Inventor: Steven Dewayne Wriggle, Alvin, TX (US)

Correspondence Address: GILBRETH & ASSOCIATES, P.C., P.O. BOX 2428, BELLAIRE, TX, 77402-2428, US

(21) Appl. No.: 10/756,787

(22) Filed: Jan. 12, 2004

Related U.S. Application Data
(60) Provisional application No. 60/439,146, filed on Jan. 10, 2003.

(51) Int. Cl. A61H 23/02

(52) U.S. Cl. 601/46; 601/70

(57) ABSTRACT

Vibrator systems, methods of making and operating such systems, and apparatus for controlling such systems. An illustrative vibration system includes first and second sets of vibrators adapted for providing therapeutic vibrations to a mammalian body, and a controller providing a first set of instructions to the first set of vibrators, and providing a second set of instructions to a second set of vibrators, wherein the first and second set of instructions are different. Another illustrative vibration system includes a therapeutic vibrator adapted for providing therapeutic vibrations to a mammalian body a controller adjustable for controlling a vibrator to a user selected amplitude of magnitude A, and which generates output instructions to the vibrator to initially operate the vibrator at an amplitude that is a fraction of A prior to generating output instructions to the vibrator to operate the vibrator at the desired amplitude A.

### RELATED APPICATION DATA

The present application claims priority of U.S. Provisional Patent Application No. 60/439,146, filed Jan. 10, 2003, fully incorporated by reference herein.

### BACKGROUND OF THE INVENTION

1. Field of the Invention

The present invention relates to vibrator systems, methods of making and operating such systems, apparatus for controlling such systems. In another aspect, the present invention relates to vibrator systems for treating mammals, methods of making and operating such systems, apparatus for controlling such systems. In even another aspect, the present invention relates to vibrator systems for treating one or more body portions of a hoofed animal, methods of making and operating such systems, apparatus for controlling such systems.

2. Description of the Related Art

The muscles of various mammals, for example, humans or horses, can be treated by application of vibrators. For example, vibrators of the commercially available type include hand held battery driven or AC current driven vibrators for use in treating the aches, strains, and pains incurred by back, shoulder, leg, arm and other muscles.

It is even possible to utilize a number of vibrators in the treatment of muscle aches, strains, and pains.

Applicant is aware of the below listed patents which relate to massage systems for humans as well as animals, and are herein incorporated by reference.

U.S. Pat. No. 4,022,195, issued May 10, 1977, to Meyer et al., discloses a combined massage and spot heating device. In particular, the device includes a cushion adapted to be placed next to the body of a person to be treated and a vibrating mechanism contained therein, and a switchbox containing switching means for controlling the amplitude of vibration, said means including a resistor inside the switchbox which may be cut into the vibrator circuit at certain positions of the switching means, the resistor serving to heat a heat-conducting plate associated with the switchbox to provide a facility for spot heating selected areas on the body of the person being treated.

U.S. Pat. No. 4,183,329, issued Jan. 15, 1980, to Leonaggeo, Jr., discloses a whirlpool therapy facility especially useful for treatment of racehorses. The facility includes a heated pool of water contained within an elongated channel-shaped tub having upstanding substantially parallel sidewalls and a pair of opposed laterally extending inclined ramps for ingress to and egress from the pool. A plurality of air induction type hydrojet water nozzles is carried by each of the sidewalls in an inverted substantially U-shaped pattern corresponding generally to the outline of the torso and legs of a horse. Turbulence in the pool is generated by jets of intermixed water and air injected under pressure through the nozzles at selected body portions of the horse to massage disfunctional or injured muscles and joints. The tub is preferably large enough to accommodate two horses in tandem for simultaneous therapy treatments.

U.S. Pat. No. 4,935,018, issued Jun. 19, 1990, to Scholz, discloses a hoof dressing applicator having an applicator band for direct attachment to the coronary band of a horse's hoof. The applicator band has three rows with each row having three sealed pouches containing equal amounts of medication totalling a two-days' supply. Each pouch has a thick tough plastic exterior wall portion superposed over a weak thin plastic interior wall portion rupturable by sufficient pressure applied to its corresponding exterior wall portion. The double-seamed margings of the pouches in common with one another are joined together by heat-sealing. A thick, flexible, soft felt backing is carried by the interior wall portions of the pouches and interfaces with the coronary band of the horse's hoof. Sufficient pressure against the exterior wall portions along a row ruptures its three interior wall portions of such pouches with slow flowing of the medication which is soaked-up the felt backing and continously applied to the coronary band. Thereafter, the horse itself therapeutically medicates itself with medication by the horse's own natural movements of its legs to thereby continually massage the medication into its coronary band.

U.S. Pat. No. 5,050,587, issued Sep. 24, 1991, to Sagara et al., discloses a vibrator system and vibrotherapeutic device, which comprises an ultrasonic motor; a driver circuit which supplies a forwardly-rotatory and reversely-rotatory signals to the ultrasonic motor; and a switching control circuit wich alternately switch the signals. The vibrator system attains a high energy efficiency even when miniaturized, as well as normally working without causing a large operation noise when loaded.

U.S. Pat. No. 5,211,131, issued May 18, 1993, to Plyler, discloses a pet grooming device that includes a vacuum system for inducing fleas, ticks, loose hair and other debris from an animal such as a cat or dog during a grooming exercise. The grooming device includes a detachable head having a front side that has a plurality of individually spaced bristles that project from the front of the grooming head and which act to massage and stimulate the hair and skin of an animal during the grooming process.

U.S. Pat. No. 5,542,907, issued Aug. 6, 1996, to Chou, discloses a massage apparatus with multiple vibrator units. The massage apparatus includes multiple vibrator units, a power converter and power supplier, and a base of hive type. The converter is electrically connected with the plurality of vibrator units respectively, and the base is provided with a plurality of cylinders for receiving the vibrator units selectively. Thus, the plurality of vibrator units can optionally massage either a single point or a specific area a patient.

U.S. Pat. No. 5,767,634, issued Jun. 16, 1998, discloses a pulse action facial massager apparatus including a headset assembly for mounting to a user's head. A pair of flexible extension fingers extending from opposite sides of the headset assembly each of which is operably coupled to a vibrating device each generating an independent vibrating action. A tip portion of each extension finger is manually movable for selected contact at independent portions of the user's head. Hence, the respective vibrating device transmits the vibrating action thereof along the extension finger to the respective tip portion. Each vibrating device includes a motor that is controlled by an electronic controller mounted on the headset assembly. The controller permits user-variation of the repetition rate and duty cycle of the motors. This permits the user to vary the vibrational patterns produced by the present invention. In an automatic mode, duty cycle is automatically varied by a sawtooth waveform to produce a dynamically changing pattern of massage intensity. The control also includes a timer that after a preset time gradually diminishes the duty cycle and thus the intensity of the vibrations.

U.S. Pat. No. 5,970,911, issued Oct. 26, 1999, to van der Lely, discloses an accommodation for animals, such as cows, including a massage member and a brushing member for massaging and brushing animals in a milking compartment wherein the animals are automatically milked. The milking compartment mounts longitudinal guide members on which the massage member and the brushing member can be moved in longitudinal directions relative to the animal while being manipulated to massage and brush the back, hind quarters and sides of the animal while the animal is being milked. The particular type and degree of brushing and/or massaging are customized to whatever is acceptable for the animal and is found to improve the animal's milk production and/or the quality of its milk. Each animal is identified and the massaging and/or brushing is applied in a manner based on parameters such as the time required to complete the milking and milk samples. In cold weather, warm air, water or oil may be applied to the animal from the massage member.

U.S. Pat. No. 6,290,661, issued Sep. 18, 2001, to Cutler et al., discloses a remote controlled massage device that includes a remote control unit having a microprocessor, a keypad, and a transmitter, the microprocessor being programmed for generating output data directly corresponding to individual keystrokes of the keypad that define activation of particular vibrator elements, operation in particular time-variant power level sequences, relative vibration intensity, and relative speed of advancing through the time-variant power sequences.

However in spite of prior art devices, there exists a need in the art for an improved vibrator system, to methods of making and operating such systems, and to apparatus for controlling such systems.

There exists another need in the art for a vibrator system that utilizes a number of vibrators that can be coordinately controlled to provide a desired type of vibratory treatment, to methods of making and operating such systems, and to apparatus for controlling such systems.

There exists even another need in the art for a vibrator system especially adapted to treat muscle aches, strains and pains, that utilizes a number of vibrators that can be coordinately controlled to provide a desired type of vibratory treatment, to methods of making and operating such systems, and to apparatus for controlling such systems.

There exists even still another need in the art for a vibrator system especially adapted to treat equine muscle aches, strains and pains, that utilizes a number of vibrators that can be coordinately controlled to provide a desired type of vibratory treatment, to methods of making and operating such systems, and to apparatus for controlling such systems.

These and other needs in the art will become apparent to those of skill in the art upon review of this specification, including its drawings and claims.

### SUMMARY OF THE INVENTION

It is an object of the present invention to provide for a vibrator system, methods of making and operating such systems, and apparatus for controlling such systems.

It is another object of the present invention to provide for a vibrator system that utilizes a number of vibrators that can be coordinately controlled to provide a desired type of vibratory treatment, to methods of making and operating such systems, and to apparatus for controlling such systems.

It is even another object of the present invention to provide for a vibrator system especially adapted to treat muscle aches, strains and pains, that utilizes a number of vibrators that can be coordinately controlled to provide a desired type of vibratory treatment, to methods of making and operating such systems, and to apparatus for controlling such systems.

It is even still another object to provide for a vibrator system especially adapted to treat equine muscle aches, strains and pains, that utilizes a number of vibrators that can be coordinately controlled to provide a desired type of vibratory treatment, to methods of making and operating such systems, and to apparatus for controlling such systems.

These and other objects of the present invention will become apparent to those of skill in the art upon review of this specification, including its drawings and claims.

According to one embodiment of the present invention, there is provided a therapeutic vibrator system comprising first and second sets of vibrators adapted for providing therapeutic vibrations to a mammalian body and a controller, in communication with and providing a first set of instructions to the first set of vibrators, and in communication with and providing a second set of instructions to a second set of vibrators, wherein the first and second set of instructions are different.

According to another embodiment of the present invention, there is provided a therapeutic vibrator controller, which includes a first zone comprising a first set of communication ports, wherein each port of the first set of ports is for providing a first set of instructions to different vibrators in a first set of vibrators, and includes a second zone comprising a second set of communication ports, wherein each port in the second set of ports is for providing a second set of instructions to different vibrators in a second set of vibrators, and wherein the first and second set of instructions are different.

According to even another embodiment of the present invention, there is provided a method for controlling first and second sets of therapeutic vibrators, the method comprising, providing a first set of instructions to the first set of vibrators, and a second set of instructions to a second set of vibrators, wherein the first and second sets of instructions are different.

According to still another embodiment of the present invention, there is provided a therapeutic vibrator system, comprising a therapeutic vibrator adapted for providing therapeutic vibrations to a mammalian body, and a controller in communication with the vibrator, wherein the controller is adjustable for controlling a vibrator to a user selected amplitude of magnitude A, and wherein the controller generates output instructions to the vibrator to initially operate the vibrator at an amplitude that is a fraction of A prior to generating output instructions to the vibrator to operate the vibrator at the desired amplitude A.

According to yet another embodiment of the present invention, there is provided a therapeutic vibrator controller, adjustable for controlling a vibrator to a user selected amplitude of magnitude A, wherein the controller generates output instructions to the vibrator to initially operate the vibrator at an amplitude that is a fraction of A prior to generating output instructions to the vibrator to operate the vibrator at the desired amplitude A.

According to even still another embodiment of the present invention, there is provided a method of controlling a therapeutic vibrator, the method comprising, determining the user desired amplitude A, providing instructions to the vibrator to initially operate the vibrator at an amplitude that is a fraction of A, and providing instructions to the vibrator to then operate the vibrator at the user desired amplitude A.

These and other embodiments of the present invention will become apparent to those of skill in the art upon review of this specification, including its drawings and claims.

### BRIEF DESCRIPTION OF THE DRAWINGS

FIG. 1 is a schematic showing one non-limiting embodiment of the present invention, showing vibrator controller 100, having face or cover plate 101, port identifiers 114 having zone 1 for ports 1 thru 3 and zone 2 for ports 4-6, on/off indicators ill, mode controls 105, intensity controls 109 and timer controls 103.

FIGS. 2-6 are schematics of various embodiments of vibrator system 200 having controller 100 of FIG. 1 (with on/off control 101 not shown), with the system powered via plus 301 connected to a AC source.

FIG. 7 is a schematic representation of the underlying circuit of one embodiment of the present invention.

FIG. 8 is a schematic of a battery option of the present invention.

FIG. 9 shows a view of ports 114 of the present invention, showing male end 211 of vibrator 201, which male end 211 is connectable to port 114.

FIG. 10 shows a vibrator 201 useful in the present invention, including foam pad comprising a motor shroud or cover in which is positioned a vibrator.

FIG. 11 is a schematic of controller 100, with vibrators 201 in communication with one zone 114, and vibrator 202 in communication with another zone 114. Vibrators 201 and 202 are positioned on vibrator positioning pad 301, generally held in place by fasteners, for example, hook and loop fasteners, brackets, clips, and the like.

### DETAILED DESCRIPTION OF THE INVENTION

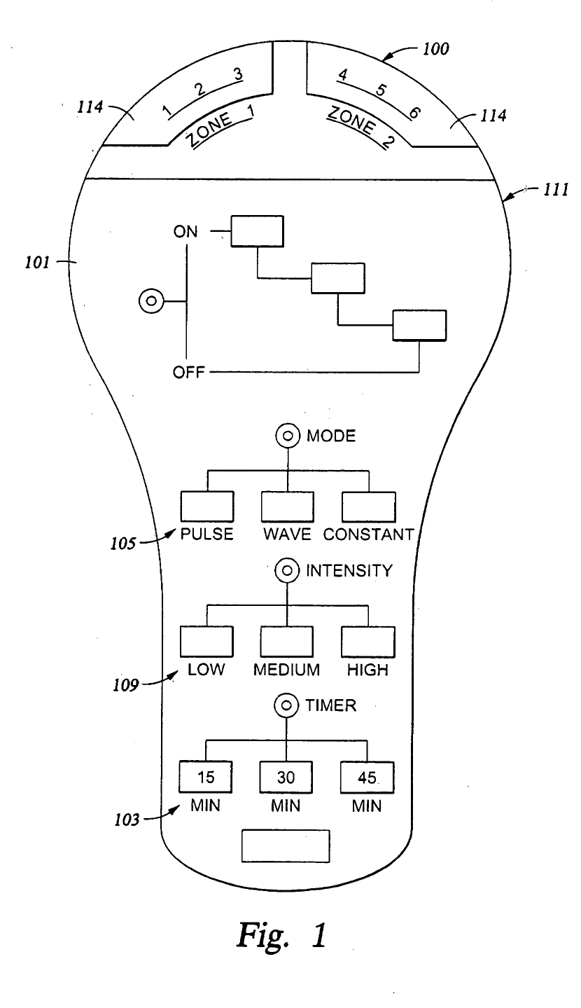

Referring now to FIG. 1, there is shown one non-limiting embodiment of the present invention, showing vibrator controller 100, having face or cover plate 101, port identifiers 114 having zone 1 for ports 1 thru 3 and zone 2 for ports 4-6, on/off indicators 111, mode control 105, intensity control 109 and timer control 103.

While controller 100 is shown having two zones having three ports each, it is understood that any number of zones having any number of ports can be utilized, with the zones not necessarily having the same number of ports. Generally, the controllers will set the operating conditions for each zone with all ports in the zone providing the same signal. Of course, each port may also be providing different signals independently.

Employed under face plate 101 are a number of lights which indicate which ports are active, and the selected mode, intensity and time. Of course, a screen display could also be utilized as a menu for selecting the various settings and/or to show the status of the various settings.

In the embodiment as shown in FIG. 1, on/off controller 101 toggles between (1) both zones off; (2) zone 1 on, zone 2 off; (3) zone 1 off, zone 2 on; and (4) both zones on. Any suitable type of on/off mechanism may be utilized. To avoid any type of sudden vibratory jolt, the embodiment as shown starts up at some fraction (“f”) of full power (⅓rd for example), and gradually increases to full power, although start up at full power is also contemplated in the present invention.

In the embodiment as shown in FIG. 1, the mode control 105 can be selected between pulse, wave and constant vibrations. Of course, in the practice of the present invention, it is understood that any type of vibratory pattern may be utilized.

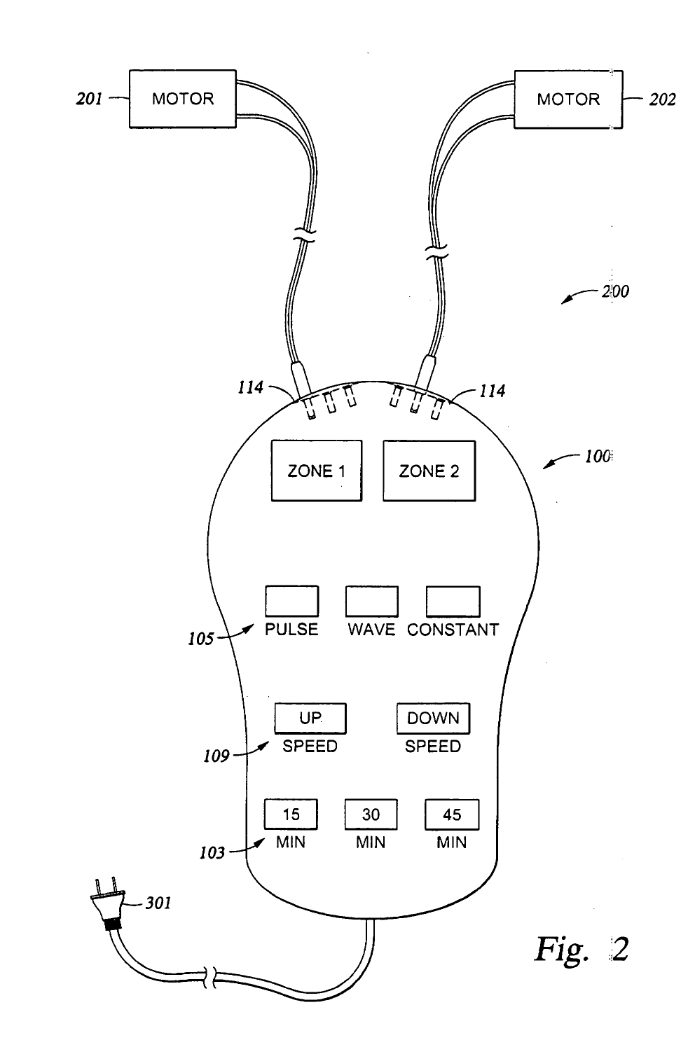

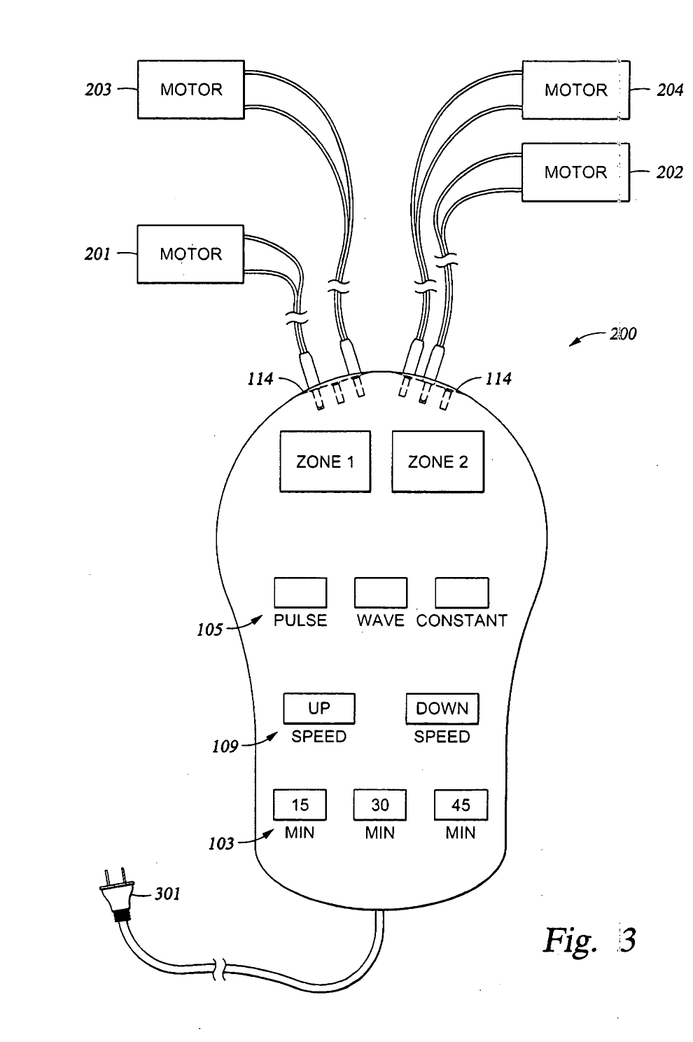

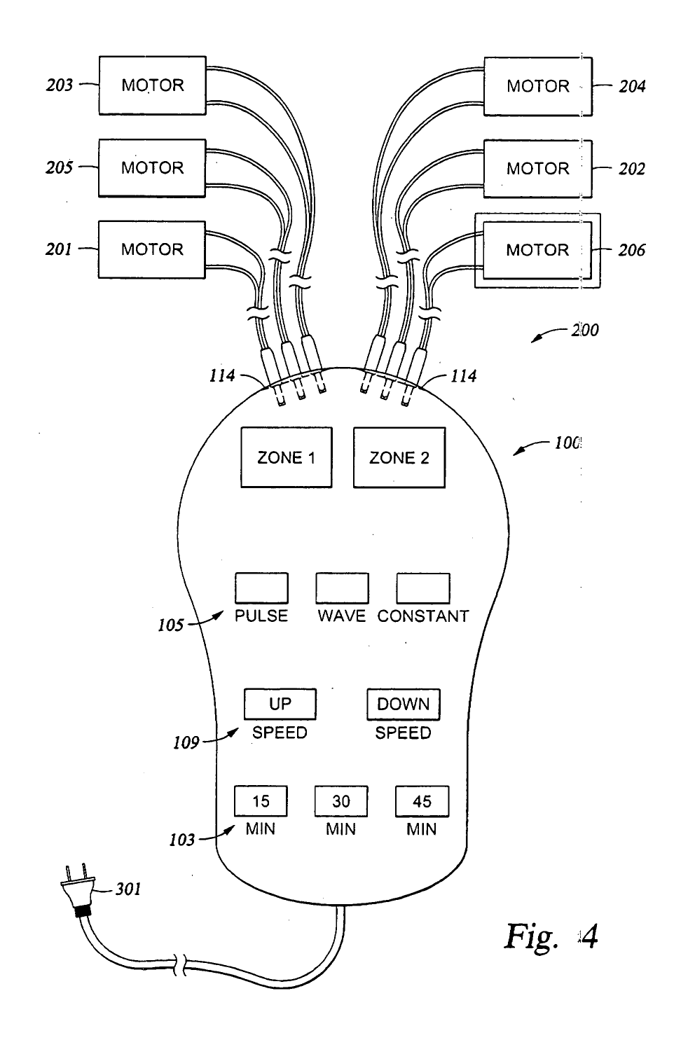

In the embodiment as shown in FIG. 1, intensity control 109 may be varied between amplitudes of “low,” “medium,” and “high” intensity. Of course, it is understood that other embodiments are contemplated in which the amplitude intensity may be varied by “up” and “down” controls as shown in the embodiments of FIGS. 2-6, or even varied by a rheostat (perhaps thumb wheel controlled), or even still varied by numerical input wherein such numerical input is indicative of a desired intensity.

In the embodiment as shown in FIG. 1, timer control 103 may be toggled between 15, 30 and 45 minutes. Of course, it is understood that other embodiments are contemplated in which vibration time is varied by “up” and “down” controls as shown in the embodiments of FIGS. 2-6, or even varied by a rheostat (perhaps thumb wheel controlled), or even still varied by numerical input wherein such numerical input is indicative of a desired time.

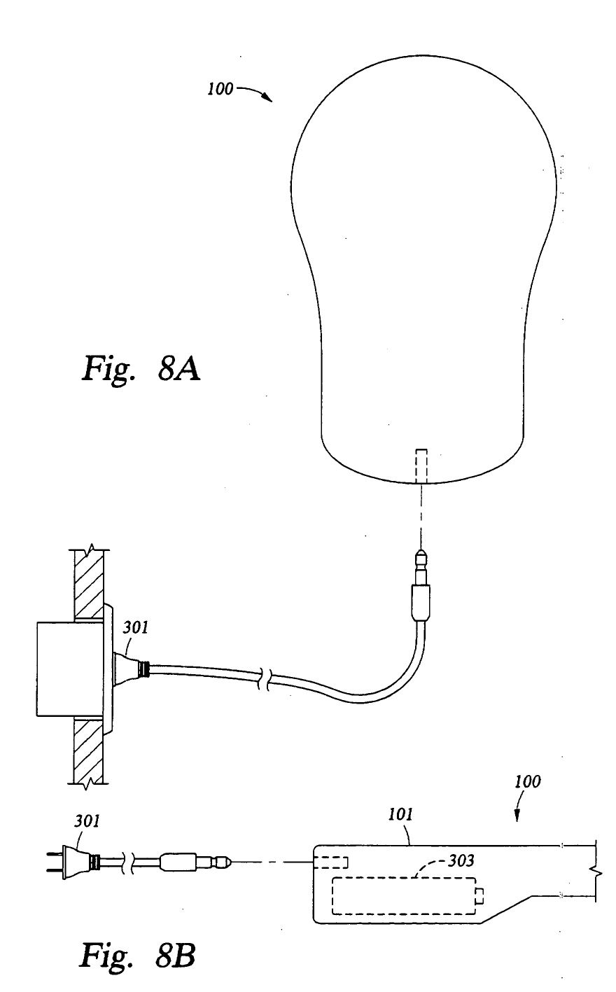

Referring additionally to FIGS. 2-6, there are shown various schematics of vibrator system 200 having controller 100 of FIG. 1 (with on/off control 101 not shown), with the system powered via plus 301 connected to a AC source (although it is contemplated that the system may also be battery powered, see FIG. 8 showing battery powered embodiment).

While the various vibrators are show in FIGS. 2-6 as hard wired to controller 100, it is understood that other embodiments of controller 100 might utilize wireless communication between controller 100 and the vibrators. For example, an infrared control system, such as that shown in U.S. Pat. No. 6,290,661. Additionally, while the embodiments shown in FIGS. 1-6 contemplate push button input of instructions into controller 100, other embodiments include wireless input of instructions, or instructions may be read into controller 100, for example, via the use of magnetic or optical data storage media.

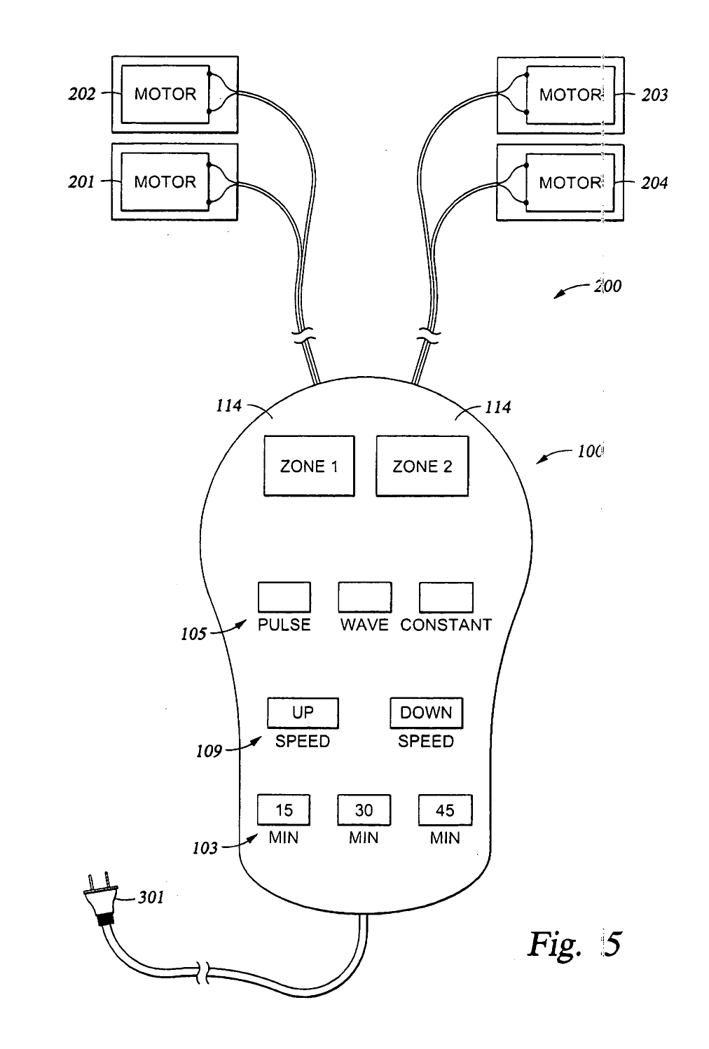

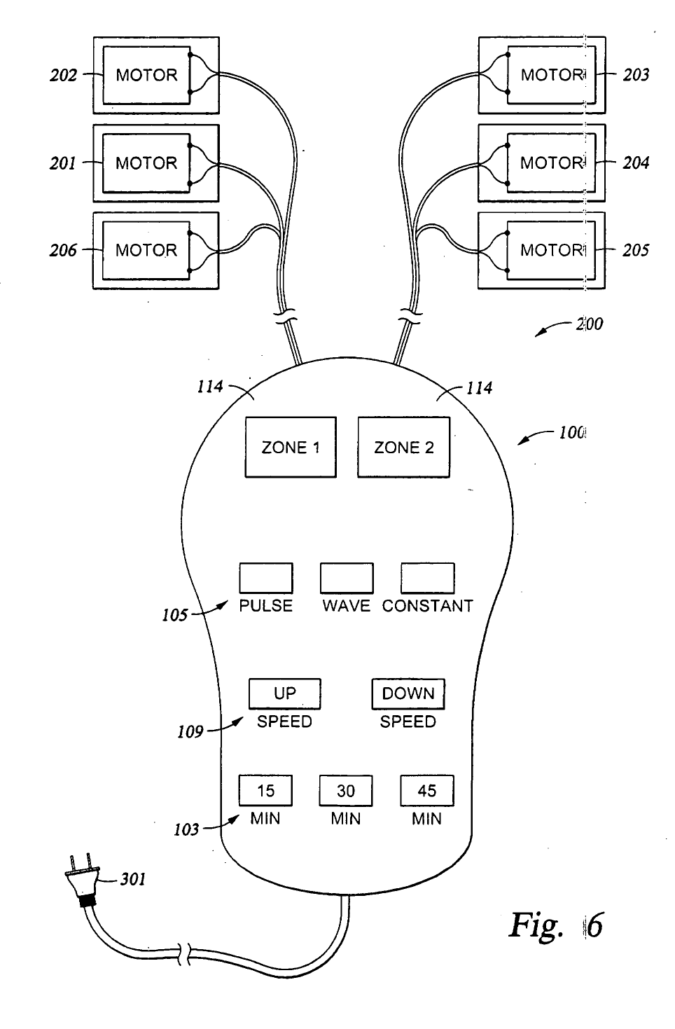

In FIGS. 2, 3 and 4, vibrators 201-206, are connected one vibrator to one port. In FIGS. 5 and 6, multiple vibrators are connected to a single port. Of course, while up to vibrators is shown in the FIGs. it is understood that the present invention is not so limited and that any desired number of vibrators may be utilized. It is also contemplated, that a vibrator system can comprise more than one controller, which controllers may or may not be in communication with each other.

In the practice of the present invention, the vibrator motors may comprise any as are known in the art. Additionally, the vibrator motors may be affixed to the treatment area by any suitable apparatus and/or method.

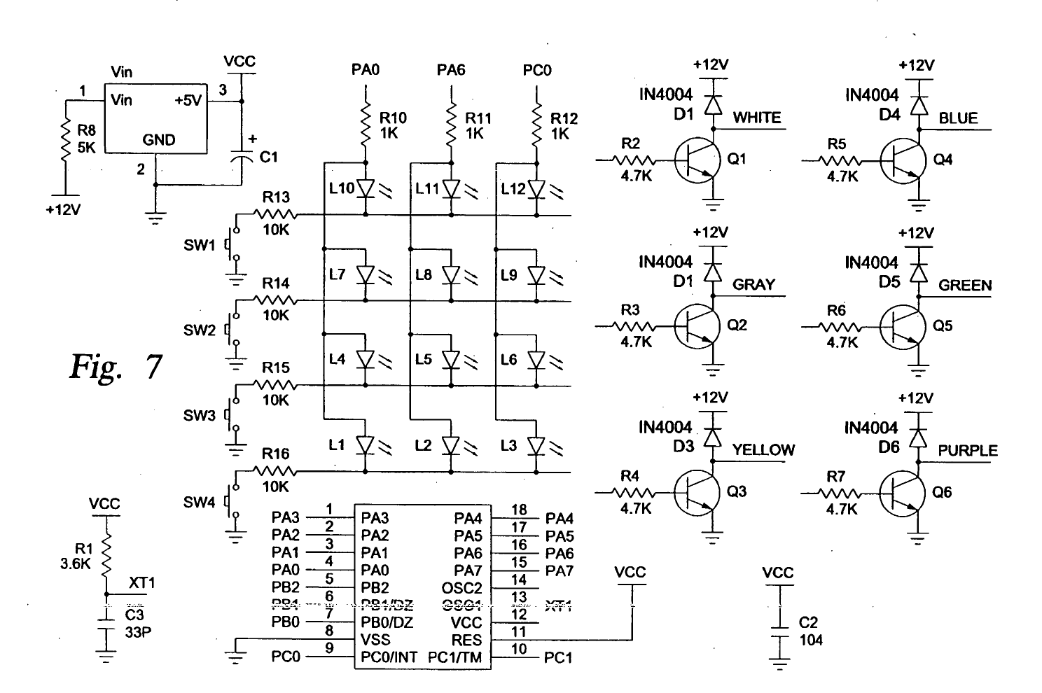

FIG. 7 is a schematic representation of the circuits underlying the embodiment of the present invention. It should also be understood that part of or any portion of the controls of controller 100 may be software driven. For example, the output signal for a particular vibration wave pattern may be generated by software and a software generated signal provided as output to a vibrator. Likewise with the intensity and/or time duration.

Thus, a product of the present invention includes computer readable media comprising instructions, or a data signal embodied in a carrier wave comprising instructions, said instructions which when carried out on a computer will implement one or more of the method steps of the present invention.

Using the foregoing specification, part or all of the present invention may be implemented using standard programming and/or engineering techniques using computer programming software, firmware, hardware or any combination or subcombination thereof. Any such resulting program(s), having computer readable program code means, may be embodied or provided within one or more computer readable or usable media such as fixed (hard) drives, disk, diskettes, optical disks, magnetic tape, semiconductor memories such as read-only memory (ROM), etc., or any transmitting/receiving medium such as the Internet or other communication network or link, thereby making a computer program product, i.e., an article of manufacture, according to the invention. The article of manufacture containing the computer programming code may be made and/or used by executing the code directly from one medium, by copying the code from one medium to another medium, or by transmitting the code over a network.

The controller of the present invention may include be one or more processing systems including, but not limited to, a central processing unit (CPU), memory, storage devices, communication links, communication devices, servers, I/O devices, or any subcomponents or individual parts of one or more processing systems, including software, firmware, hardware or any combination or subcombination thereof, which embody the invention as set forth in the claims. User input may be received from the keyboard, mouse, pen, voice, touch screen, or any other means by which a human can input data to a computer, including through other programs such as application programs. One skilled in the art of computer science will easily be able to combine the software created as described with appropriate general purpose or special purpose computer hardware to create a computer system and/or computer subcomponents embodying the invention and to create a computer system and/or computer subcomponents for carrying out the method of the invention.

FIG. 8 is a schematic of a battery option of the present invention.

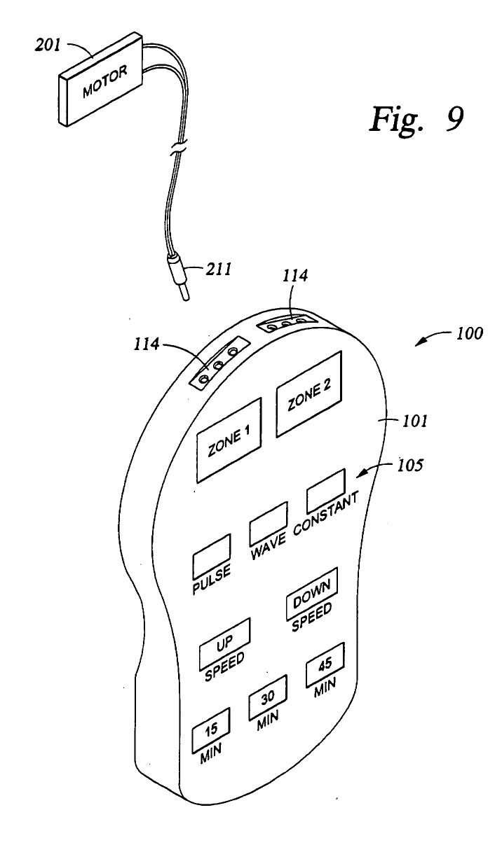

FIG. 9 shows a view of ports 114 of the present invention, showing male end 211 of vibrator 201, which male end 211 is connectable to port 114.

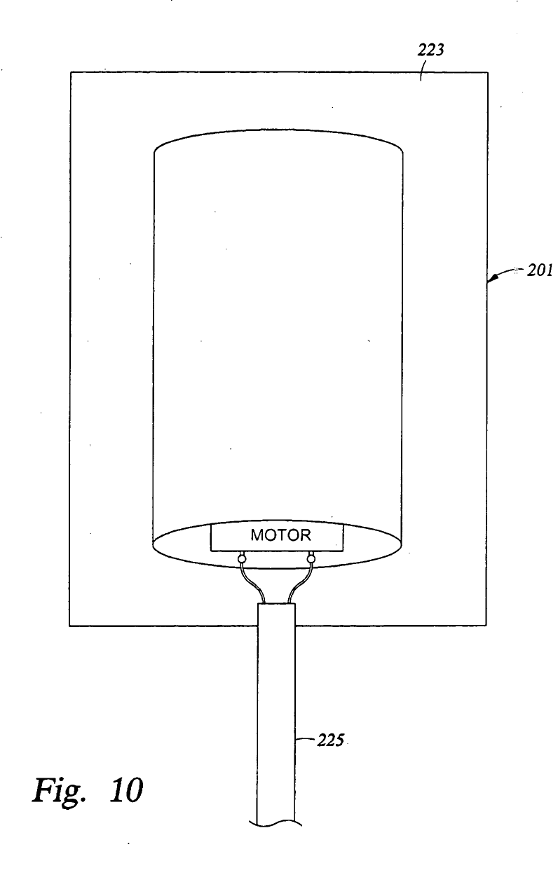

FIG. 10 shows a vibrator 201 useful in the present invention, including foam pad comprising a motor shroud or cover in which is positioned a vibrator.

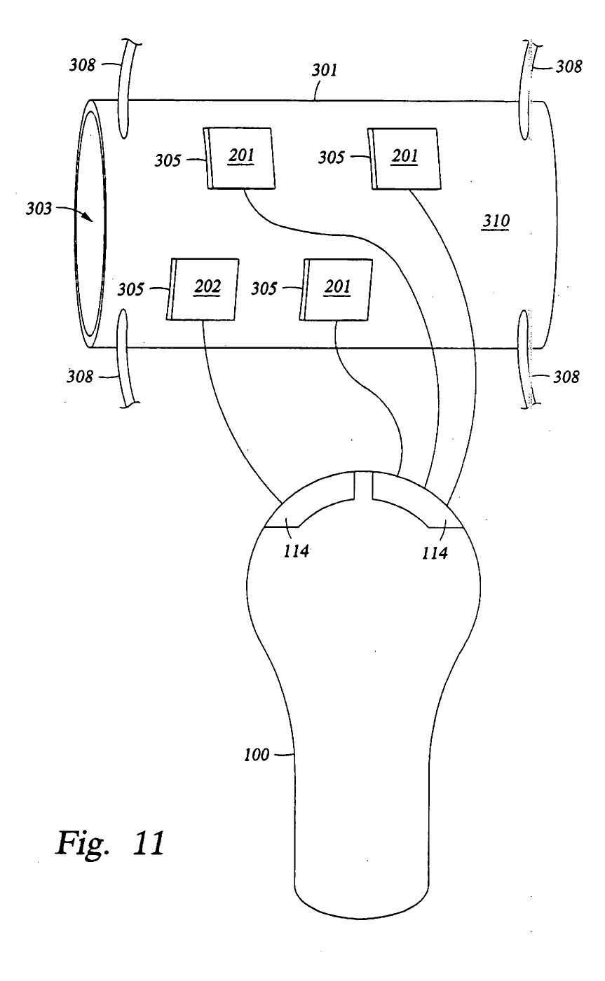

FIG. 11 is a schematic of controller 100, with vibrators 201 in communication with one zone 114, and vibrator 202 in communication with another zone 114. Vibrators 201 and 202 are positioned on vibrator positioning pad 301, generally held in place by fasteners, for example, hook and loop fasteners, brackets, clips, and the like. In the embodiment as shown, vibrators 201 and 202 are held in place by hook and loop system 305 and 310. Vibrator positioning pad 301 may be held in place by use of straps 308.

It should be clear that any conceivable arrangement of vibrators on pad 301 may be obtained by the use of fasteners. Pad 301 may also be designed to receive a limb, torso, or any portion of a body for treatment. For example, a tubular shaped pad 301 may be slipped over an arm, leg, or torso. Of course, while a flat pad 301 could also be placed on a arm, leg or torso, a tubular shaped pad 301 could be made to form fit, and would thus stay positioned easier.

As a further embodiment, it is anticipated that magnets for magnetic therapy, could be positioned in or on pad 301, with or without vibrators, using, of course, any suitable fastener as described above.

It is also anticipated that gel pads (which can be made hot or cold) can be utilized in conjunction with the present invention. These gel pads can additionally be form fitted for a particular area or body part. Optionally, vibrator positioning pad 301 forms enclosure 303 into which heated or cooled gel packs may be positioned.

In operation, the various vibrators are affixed to the desired treatment areas. These various vibrators are either in communication with a controller prior to being affixed or placed in communication with the controller after being affixed in place. Instructions regarding control of these various vibrators are either provided to the controller before or after the vibrators are placed in communication with the controller. Upon starting, the various vibrators are then controlled by the controller to provide a desired treatment regimen.

The present invention may also be utilized in the treatment of more than one mammal at a time.

While the present invention most likely finds utility with humans or horses, it is anticipated to find most use with domestic representatives of the mammalian grouping, ungulates, include but are not limited to, sheep, goats, camels, pigs, cows, and horses. The hooves of each type of animal, and different breeds and stages of maturity within each type, can have different shapes and sizes of hooves. Different embodiments of the present invention would be appropriate for different groups of individuals in each ungulate type, with the invention preferably utilized with horses.

The present invention also finds utility in the treatment of wild hoofed animals, for example, in captivity in zoo or wildlife safari park settings, or even in the habilitation of wild animals.

It is also contemplated that the present invention may be used in conjunction with other apparatus and methods for treating an ungulate's hoof, for example, boot type devices which can be used for applying hot or cold temperatures, or for providing a temperature treatment at the same time that a medicine is applied directly to the hoof region, or finally for treating a hoof with only a medicine applied to the hoof with no external temperature addition.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

1. A therapeutic vibrator system comprising:
first and second sets of vibrators adapted for providing therapeutic vibrations to a mammalian body; and
a controller, in communication with and providing a first set of instructions to the first set of vibrators, and in communication with and providing a second set of instructions to a second set of vibrators, wherein the first and second set of instructions are different.

2. The system of claim 1, wherein the controller controls one or more of the vibration amplitude and vibration wave type, and time duration of vibration.

3. A therapeutic vibrator controller comprising:
a first zone comprising a first set of communication ports, wherein each port of the first set of ports is for providing a first set of instructions to different vibrators in a first set of vibrators; and
a second zone comprising a second set of communication ports, wherein each port in the second set of ports is for providing a second set of instructions to different vibrators in a second set of vibrators, and wherein the first and second set of instructions are different.

4. The controller of claim 3, wherein the controller controls one or more of the vibration amplitude and vibration wave type, and time duration of vibration.

5. A method for controlling first and second sets of therapeutic vibrators, the method comprising, providing a first set of instructions to the first set of vibrators, and a second set of instructions to a second set of vibrators, wherein the first and second sets of instructions are different.

6. A therapeutic vibrator system, comprising:
a therapeutic vibrator adapted for providing therapeutic vibrations to a mammalian body; and
a controller in communication with the vibrator, wherein the controller is adjustable for controlling a vibrator to a user selected amplitude of magnitude A, and wherein the controller generates output instructions to the vibrator to initially operate the vibrator at an amplitude that is a fraction of A prior to generating output instructions to the vibrator to operate the vibrator at the desired amplitude A.

7. A therapeutic vibrator controller, adjustable for controlling a vibrator to a user selected amplitude of magnitude A, wherein the controller generates output instructions to the vibrator to initially operate the vibrator at an amplitude that is a fraction of A prior to generating output instructions to the vibrator to operate the vibrator at the desired amplitude A.

8. A method of controlling a therapeutic vibrator, the method comprising:
determining the user desired amplitude A;
providing instructions to the vibrator to initially operate the vibrator at an amplitude that is a fraction of A; and
providing instructions to the vibrator to then operate the vibrator at the user desired amplitude A.
